(19) United States
(12) Patent Application Publication
(10) Pub. No.: US 2008/0179838 A1
(43) Pub. Date: Jul. 31, 2008

(54) Expansion Chuck

(76) Inventors: Thomas Retzbach, Bonningheim (DE); Andreas Schuster, Wustenrot/Neulautern (DE)

Correspondence Address: JOSEPH W. BERENATO , III;BERENATO, WHITE & STAVISH, LLC, 6550 ROCKSPRING DRIVE, SUITE 240, BETHESDA, MD, 20817, US

(21) Appl. No.: 10/578,429

(22) PCT Filed: Nov. 4, 2004
(86) PCT No.: PCT/EP04/12491

§ 371 Date: Mar. 19, 2008

(30) Foreign Application Priority Data
Nov. 5, 2003 (EP) 03025239.9

(51) Int. Cl. B23B 31/40

(52) U.S. Cl. 279/2.08

(57) ABSTRACT

The invention relates to an expansion chuck comprising a base, a thin-walled expansion sleeve that is disposed in a final axial zone of the base and forms a central seat for a component that is to be clamped, and a clamping ring which surrounds the expansion sleeve so as to form an intermediate annular pressure chamber and is screwed to the base. Said pressure chamber is filled with a hydraulic means while the expansion sleeve can be elastically deformed for fixing a component within the seat by axially displacing the clamping ring, said clamping ring being twisted in relation to the base such that the volume of the pressure chamber decreases. The inventive expansion chuck is characterized in that the pressure chamber is filled wit a hydraulic means while a sliding ring element is placed between the ela: pressure surface of the clamping ring in order to transmit an axial con clamping ring to the solid body.

This invention relates to an expanding clamping device having a base body, a thin-walled expansion sleeve which is provided on an axial end portion of the base body and forms a central receptacle for a work piece that is to be clamped, and a tension ring that surrounds the expansion sleeve forming an annular pressure chamber therebetween and is connected to the base body by screwing, wherein the pressure chamber is filled with a hydraulic medium and the expansion sleeve can be elastically deformed in order to fix a work piece in the receptacle by turning the tension ring relative to the base body in order to axially displace it, thereby reducing the volume of the pressure chamber.

Expanding clamping devices of this type are known and used in practice in order to fix a tool such as, for example, a milling or boring tool, onto the working spindle of a corresponding machine tool. For this, the shaft of the tool to be clamped is inserted into the receptacle of the expanding clamping chuck, and then the tension ring is screwed onto the expansion sleeve, thereby reducing the volume of the pressure chamber so that said tension ring is inwardly deformed by the growing pressure in the pressure chamber, and fixes the tool shaft in the receptacle.

With an expanding clamping device which is known from DE 195 25 574 C1, and according to the preamble to claims 1 and 2, a liquid hydraulic medium, such as oil for example, is used. However, this is associated with the disadvantage that complex sealing measures have to be taken in order to prevent the liquid hydraulic medium from leaking with the partially very high operational pressures.

It is therefore the object of this invention to design an expanding clamping device of the type specified at the start which is of simple structure and which in particular does not require any complex sealing measures.

This object is fulfilled according to the invention in that the pressure chamber is filled with an elastic solid body as the hydraulic medium, and a sliding ring element is provided between the elastic solid body and a pressure face of the tension ring in order to transfer an axial pressing force from the tension ring to the solid body. The idea which forms the basis of the invention is therefore to fill the pressure chamber not with a liquid hydraulic medium, as in the prior art, but with an elastic and also annular solid body so that complex sealing measures can be dispensed with. The sliding ring inserted into the pressure chamber ensures here that the annular solid body is at least largely uncoupled from the rotational movements of the tension ring in the region of its face surface pointing towards the pressure face of the tension ring, and so that over this face surface only pressing forces, and no friction or torsional forces, are introduced into the solid body. It has been shown that in this way, extrusion of the elastic solid body material is avoided, and also wear can be kept very low. Moreover, the sliding ring, which can be made for example of an appropriate metal alloy or of a ceramic material, can at the same time also have a sealing function if a liquid lubricant is provided between the outer circumference of the solid body and the inner circumference of the tension ring in order to keep the friction occurring when the tension ring is turned at a low level.

According to one embodiment of the invention, provision is made such that the solid body consists of several ring elements disposed in the pressure chamber, lying next to one another. The pressure chamber here should have an at least essentially constant inner and outer diameter.

In a further embodiment of the invention, a stop can be provided which limits the axial displacement movement of the tension ring such that the maximum achievable pressure within the pressure chamber is limited to a defined degree.

Furthermore, engagement means can be provided on the tension ring for operating elements such as for example a roller or hook wrench.

Finally, the expanding clamping device according to the invention can be used for a shaft/collar connection. It can also be provided stationary on a work bench or similar.

Moreover, the expanding clamping device according to the invention can also be in the form of a clamping mandrel. In this case, it has a base body, a thin-walled expansion sleeve which is provided on an axial end portion of the base body, and a tension ring which engages in the expansion sleeve forming an annular pressure chamber therebetween and is connected to the base body by screwing, the pressure chamber being filled with an elastic solid body as the hydraulic medium, and a sliding ring element being disposed between the elastic solid body and a pressure face of the tension ring in order to transfer axial pressure forces from the tension ring to the solid body. With this embodiment as a clamping mandrel, the expansion sleeve is outwardly deformed as pressure builds up in the pressure chamber in order to fix a work piece pushed onto the expansion sleeve.

With regard to further advantageous embodiments of the invention, reference is made to the sub-claims and to the following description of an example of an embodiment, with reference to the attached drawings. In the drawings:

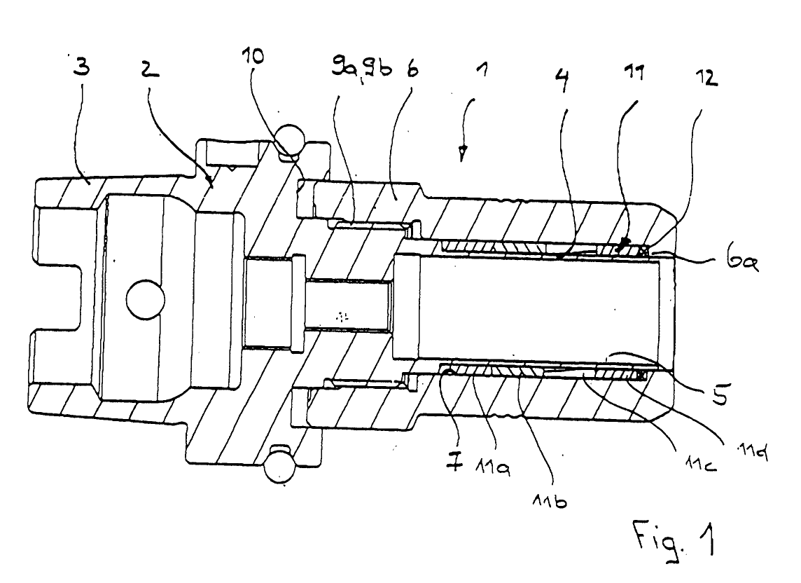

FIG. 1 shows a longitudinal section of a first embodiment of an expanding clamping device in the form of an expanding clamping chuck according to this invention in its non-operational state,

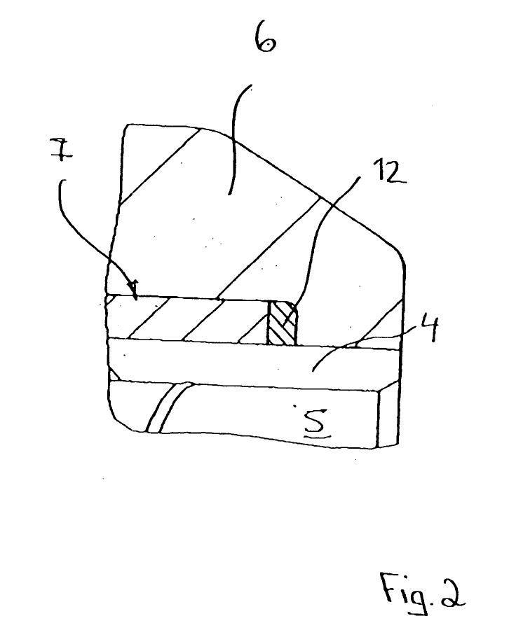

FIG. 2 shows the detail X from FIG. 1, enlarged, and

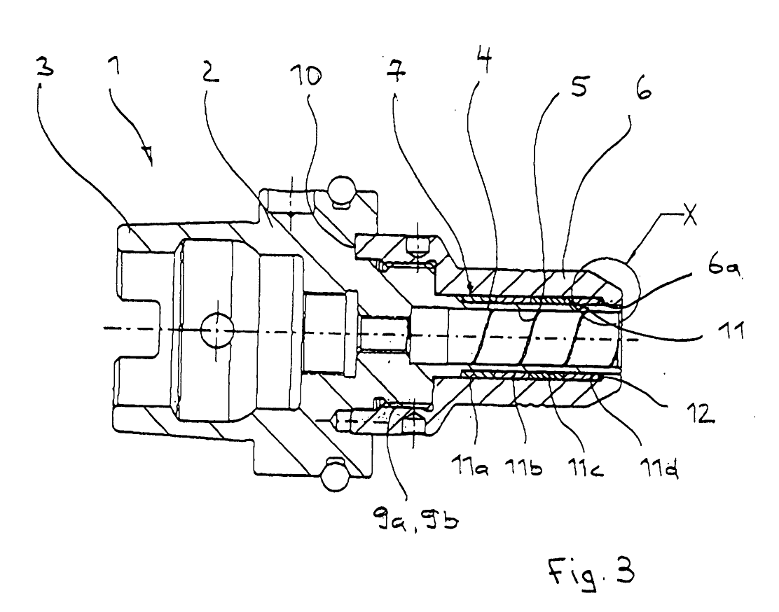

FIG. 3 shows the expanding clamping chuck from FIG. 1 in operational state.

FIG. 1 shows a longitudinal section of an embodiment of an expanding clamping chuck 1 in the form of a steep angle taper tool holder according to this invention. The expanding clamping chuck 1 comprises a base body 2 made of a rigid material which on its end portion on the left in the drawing has, in a known way, an attachment cone 3 for clamping to a rotationally driven working spindle of a machine tool. On the other axial end of the base body 2, a thin-walled expansion sleeve 4 is provided which is here formed integrally with the base body 2, but alternatively can also be a separate component which is securely connected to the base body 2. The expansion sleeve 4 forms a central receptacle 5 into which a cylindrical shaft of a tool, such as for example a borer or cutter to be clamped, can be inserted.

The expansion sleeve 4 is surrounded by a tension ring 6 in the form of a retainer nut which on its axial end facing the attachment cone 3 is screwed onto the base body 2, for which purpose corresponding thread sections 9a, 9b are formed on the base body 2 and on the inside of the tension ring 6. The expansion sleeve 4 and the tension ring 6 form between them an annular pressure chamber 7 with a constant inner and outer diameter, and which on its axial end facing the attachment cone 3 is defined by a protrusion 4a of the expansion sleeve 4 and on its other axial end by a shoulder 6a of the tension ring 6. The pressure chamber 7 is filled with an elastic solid body 11 which, in the embodiment shown, is formed by four ring elements 11a, 11b, 11c, 11d lying next to one another. In addition, on the right hand end of the pressure chamber 7, between the shoulder 6a of the tension ring 6 and the face surface of the ring element lid lying on the outside and facing this shoulder 6a, a sliding ring 12 is provided which on the one hand uncouples the tension ring 6 from the solid body 11 in the region of the shoulder 6a, and on the other hand acts as a sealing element for a lubricant which is provided in the annular gap between the solid body 11 and the tension ring 6.

The pressure within the pressure chamber 7 can be changed if the tension ring 6 is turned in relation to the base body 2, and in this way is axially displaced so that the volume of the pressure chamber 7 changes. Specifically, the arrangement is such that in the right hand end position of the tension ring 6 shown in FIG. 1, the volume of the pressure chamber 7 is so great that the tension of the elastic ring elements 11 is released in the pressure chamber 7. If the tension ring 6 is screwed onto the base body 2 and out of the end position shown in FIG. 1, until it reaches the left hand end position 1 shown in FIG. 3, in which the tension ring 6 is in contact with an axial stop 10 of the base body 2, the axial length of the pressure chamber 7, and so its volume, is constantly reduced. The elastic ring elements 11a to 11d are pressed together elastically here so that the pressure within the pressure chamber 7 is increased, and the thin-walled expansion sleeve 4 is inwardly deformed so as to clamp a work piece inserted into the receptacle 5. When the tension ring 6 is displaced from the end position shown in FIG. 1 and into the end position shown in FIG. 3, essentially purely axial pressing forces are introduced into the ring elements 11 because the ring elements 11 are uncoupled from the tension ring 6 at their outer circumference by means of the lubricant provided and on their face surface pointing towards the shoulder 6a by means of the sliding ring 12 so that this can substantially move freely in relation to the solid body 11.

1. Expanding clamping chuck having a base body (2), a thin-walled expansion sleeve (4) which is provided on an axial end portion of the base body (2) and forms a central receptacle (5) for a work piece that is to be clamped, and a tension ring (5) that surrounds the expansion sleeve (4) forming an annular pressure chamber (7) therebetween and is connected to the base body (2) by screwing, wherein the pressure chamber (7) is filled with a hydraulic medium (11) and the expansion sleeve (4) can be elastically deformed in order to fix a work piece in the receptacle (5) by turning the tension ring (6) relative to the base body (2) in order to axially displace it, thereby reducing the volume of the pressure chamber (7), characterized in that the pressure chamber (7) is filled with an elastic solid body (11) as the hydraulic medium and a sliding ring element (12) is provided between the elastic solid body (11) and a pressure face (6a) of the tension ring (6) in order to transfer a pressing force from the tension ring (6) to the solid body (11).

2. Expanding clamping device with a base body (2), a thin-walled expansion sleeve (4) which is provided on an axial end portion of the base body (2) and a tension ring (6), which engages the expansion sleeves (4) forming an annular pressure chamber (7) therebetween and is connected to the base body (2) by screwing, wherein the pressure chamber (7) is filled with a hydraulic medium (11) and the expansion sleeve (4) can be elastically deformed in order to fix a work piece in the receptacle (5) by turning the tension ring (6) relative to the base body (2) in order to axially displace it, thereby reducing the volume of the pressure chamber (7), characterized in that the pressure chamber (7) is filled with an elastic solid body (11) as the hydraulic medium and a sliding ring element (12) is provided between the elastic solid body (11) and a pressure face (6a) of the tension ring (6) in order to transfer a pressing force from the tension ring (6) to the solid body (11).

3. Expanding clamping device according to claim 1, characterized in that the solid body (11) comprises several adjacently disposed ring elements (11a, 11b, 11c, 11d).

4. Expanding clamping device according to claim 1, characterized in that the pressure chamber (7) has an essentially constant inner and/or outer diameter.
